(19) United States
(12) Patent Application Publication
(10) Pub. No.: US 2026/0147092 A1
(43) Pub. Date: May 28, 2026

(54) METHOD FOR OPERATING A DETECTION DEVICE WITH INTERFERENCE TREATMENT USING AN ARTIFICIAL NEURAL NETWORK

(71) Applicant: VALEO SCHALTER UND SENSOREN GMBH, Bietigheim-Bissingen (DE)

(72) Inventors: Heinrich Gotzig, Bietigheim-Bissingen (DE); Paul-David Rostocki, Bietigheim-Bissingen (DE); Mohamed-Elamir Mohamed, Bietigheim-Bissingen (DE)

(73) Assignee: VALEO SCHALTER UND SENSOREN GMBH, Bietigheim-Bissingen (DE)

(21) Appl. No.: 19/123,226

(22) PCT Filed: Oct. 17, 2023
(86) PCT No.: PCT/EP2023/078746

§ 371 Date: Apr. 22, 2025

(30) Foreign Application Priority Data
Oct. 24, 2022 (DE) 10 2022 127 989.8

(51) Int. Cl. G01S 7/41; G01S 7/02; G06N 3/0464

(52) U.S. Cl. CPC G01S 7/417; G01S 7/021; G01S 7/023; G06N 3/0464

(57) ABSTRACT

A method for operating a detection device, a detection device, and a driver assistance system and a vehicle are disclosed herein. The method includes emitting at least one electromagnetic beam by the detection device into a monitoring region of the detection device; receiving at least one electromagnetic beam coming from the monitoring region and converts it into at least one detection variable which can be processed with at least one evaluation device; performing, based on at least one detection variable, at least one interference treatment using at least one artificial neural network; performing at least one interference analysis; examining the at least one detection variable for known interference patterns of interference variables using at least one artificial neural network; correcting, if at least one known interference pattern is recognized, the at least one detection variable by interference variables that belong to the at least one recognized interference pattern.

### TECHNICAL FIELD

The invention relates to a method for operating a detection apparatus, in particular a detection apparatus for a vehicle, in which
at least one electromagnetic beam is transmitted into a monitoring region of the detection apparatus using the detection apparatus,
at least one electromagnetic beam coming from the monitoring region is received using the detection apparatus and is converted into at least one capture variable that can be processed using at least one evaluation device,
at least one interference handling process is carried out on the basis of at least one capture variable using at least one artificial neural network.

The invention also relates to a detection apparatus, in particular a detection apparatus for a vehicle,
having at least one transmitting device for transmitting electromagnetic beams into a monitoring region of the detection apparatus,
having at least one means for receiving electromagnetic beams coming from the monitoring region and for determining capture variables from received electromagnetic beams,
having at least one means for carrying out interference handling processes on the basis of capture variables, wherein the at least one means has at least one artificial neural network.

In addition, the invention relates to a driver assistance system, in particular a driver assistance system for a vehicle, having at least one detection apparatus, wherein the at least one detection apparatus has
at least one transmitting device for transmitting electromagnetic beams into a monitoring region of the at least one detection apparatus,
at least one means for receiving electromagnetic beams coming from the monitoring region and for determining capture variables from the received electromagnetic beams,
at least one means for carrying out interference handling processes on the basis of capture variables, wherein the at least one means has at least one artificial neural network.

Moreover, the invention relates to a vehicle having at least one detection apparatus, wherein the at least one detection apparatus has
at least one transmitting device for transmitting electromagnetic beams into a monitoring region of the at least one detection apparatus,
at least one means for receiving electromagnetic beams coming from the monitoring region and for determining capture variables from the received electromagnetic beams,
at least one means for carrying out interference handling processes on the basis of capture variables, wherein the at least one means has at least one artificial neural network.

### PRIOR ART

A method for operating a radar system having at least two radar sensors is known from DE 10 2020 107 372 A1. In this case, provision is made, in particular, for the following steps to be carried out, preferably in succession in the stated order or in any order, wherein individual and/or all steps can also be carried out repeatedly:
carrying out signal emission in the radar sensors in order to emit at least one radar signal in each case (by way of the radar sensors), preferably by way of at least one transmitting antenna of the respective radar sensor, in particular in the form of an electromagnetic signal, emitted into an environment outside the radar sensor,
carrying out signal processing in the radar sensors such that the radar sensors each determine capture variable specific to the respectively emitted radar signal, in particular specific to the emitted radar signal which is reflected at a target object and is delayed by a signal propagation time and can be received, for example, by at least one receiving antenna of the radar sensor,
carrying out interference evaluation in order to detect in each case at least one interference in the radar sensors on the basis of the respective capture variable, wherein the interference evaluation can preferably be carried out centrally for all of the capture variables or individually for the respective capture variables in the respective radar sensors,
providing at least one or at least two or at least four or at least six adaptation option(s) for avoiding the at least one detected interference by adapting the signal emission,
carrying out an assessment of the at least one adaptation option for each of the radar sensors, in particular by way of each of the radar sensors,
carrying out an adjustment of the adaptation option between the various radar sensors on the basis of the assessment,
carrying out the adaptation of the signal emission according to the at least one adaptation option on the basis of the adjustment, in particular only when the adaptation option causes a reduction in interference for the majority of the radar sensors, and/or by selecting that adaptation option that causes the reduction in interference for the majority of the radar sensors.

The invention is based on the object of designing a method, a detection apparatus, a driver assistance system and a vehicle of the type mentioned at the outset that allow the determination of capture variables to be improved. In particular, the intention is to improve a signal-to-noise ratio for the capture variables. In particular, the intention is to alternatively or additionally improve the determination of the capture variables with regard to an outlay, in particular with regard to the outlay on materials, the outlay on components and/or the installation outlay, and/or with regard to the validity of the capture variables.

### DISCLOSURE OF THE INVENTION

The object is achieved, according to the invention, in the case of the method by virtue of the fact that at least one interference analysis is carried out during the at least one interference handling process, in which analysis the at least one capture variable is examined for known interference patterns of interference variables using at least one artificial neural network and, if at least one known interference pattern is recognized, the at least one capture variable is purged of interference variables belonging to the at least one recognized interference pattern.

According to the invention, at least one electromagnetic beam is transmitted into a monitoring region. At least one electromagnetic beam coming from the monitoring region is received using the detection apparatus and is converted into at least one capture variable.

Electromagnetic beams coming from the monitoring region can be advantageously converted into capture variables in the form of electrical receive signals using means of the detection apparatus, in particular using at least one receiving device that can have at least one antenna. Electrical receive signals can be processed using electrical means, in particular electrical control and/or evaluation devices.

Electromagnetic beams which can be received by the detection apparatus may have or consist of electromagnetic echo beams. Electromagnetic echo beams may come from electromagnetic beams which were transmitted using the detection apparatus and were reflected at at least one object. The capture variables which are determined from echo beams are specific to the reflecting object. For the sake of better distinguishability, capture variables which come solely from echo beams can also be referred to as “echo receive variables”.

Alternatively or additionally, received electromagnetic beams may have or consist of interference beams from interference sources. Interference beams received using the detection apparatus are converted into corresponding receive variables in a similar manner to the echo beams. For the sake of better distinguishability, receive variables which come solely from interference variables can also be referred to as “interference variables”.

The capture variables may be superimpositions of any echo receive variables and any interference variables. If no interference beams are captured, the capture variables consist solely of echo variables, if present. If no echo beams are captured, the capture variables consist solely of interference variables, if present.

According to the invention, at least one interference handling process is carried out on the basis of at least one capture variable using at least one artificial neural network in order to reduce an influence of any interference sources and the corresponding interference variables on the determination of information relating to the monitoring region, in particular object information relating to objects in the monitoring region.

Object information may be distance variables, direction variables and/or speed variables which characterize distances, directions and/or speeds of objects relative to the detection apparatus or a corresponding reference point or reference system.

At least one interference analysis is carried out during the at least one interference handling process. During the at least one interference analysis, the at least one capture variable is examined for known interference patterns. The known interference patterns come from interference variables that are known before carrying out the interference analysis. If a known interference pattern is recognized, the capture variable is purged of the corresponding interference variables.

Known interference sources may be external interference sources, in particular. The external interference sources may be other radiation sources, in particular radar sources, which transmit electromagnetic beams in the same wavelength range as the detection apparatus according to the invention or in an overlapping wavelength range.

Interference beams from known interference sources can cause characteristic interference patterns in the corresponding interference variables determined using the detection apparatus. In particular, corresponding noise patterns from known interference sources can be identified in the determined capture variables. Accordingly, if known interference patterns are recognized, the capture variables can be purged of the corresponding interference variables. The signal-to-noise ratio of capture variables, in particular of echo receive variables contained therein, can therefore be improved overall.

According to the invention, machine learning is used to analyze the capture variables. Depending on the type of object, the material, the shape, the X-Y-Z coordinates, the environmental conditions (for example rain), the extraneous noise, the dynamics of the environment or of the object and other factors, the shape of the received electromagnetic beams is different and also depends on the transmitted electromagnetic beams.

The interference analysis uses at least one artificial neural network. A suitable multilayer neural network (deep neural network) having an input layer, some intermediate layers (hidden layers) and an output layer can be specified for this purpose. For training, some different scenarios can be recorded in advance using the detection apparatus and can be used to train the neural network. Depending on the type of application and the degree of automation, for example SAE level 0 to SAE level 4, different classes can be used.

Purging the at least one capture variable with the aid of the at least one interference analysis also makes it possible to determine sufficiently good data using a detection apparatus having lower-precision components. It is also possible to use components that may be fraught per se with greater noise. Simpler and more inexpensive components can therefore be used overall for the detection apparatus which can nevertheless be used to determine sufficiently good capture variables for the application and the possibly corresponding degree of automation. The performance of the detection apparatus can therefore be improved by correcting the measurements with the aid of the at least one interference analysis.

The validity of the data determined therefrom can be improved by improving the signal-to-noise ratio of the capture variables. Higher safety levels can therefore be achieved using the detection apparatus according to the invention. The detection apparatus according to the invention can be used to determine data which comply with automation levels SAE 0 to 4 which are required for autonomous or semiautonomous driving.

The invention can advantageously be used in detection apparatuses for vehicles, in particular motor vehicles. Advantageously, the invention can be used in detection apparatuses for land vehicles, in particular automobiles, trucks, buses, motorcycles or the like, aircraft, in particular drones, and/or watercraft. The invention can also be used in detection apparatuses for vehicles that can be operated autonomously or at least semiautonomously. However, the invention is not restricted to detection apparatuses for vehicles. It can also be used for detection apparatuses in steady-state operation, in robotics and/or in machines, in particular construction or transport machines, such as cranes, excavators or the like.

The detection apparatus can advantageously be connected to or can be part of at least one electronic control apparatus of a vehicle or of a machine, in particular a driver assistance system and/or a chassis control system and/or a driver information device and/or a parking assistance system and/or a gesture recognition system or the like. In this way, at least some of the functions of the vehicle or of the machine can be performed autonomously or semiautonomously using the information obtained with the detection apparatus.

The detection apparatus can be used to capture stationary or moving objects, in particular vehicles, persons, animals, plants, obstacles, uneven road surfaces, in particular potholes or rocks, road boundaries, traffic signs, open spaces, in particular parking spaces, precipitation or the like, and/or movements and/or gestures.

In one advantageous configuration of the method, the at least one interference analysis can be carried out repeatedly and the purged capture variables determined from the respective interference analyses can be combined to form at least one combination capture variable. This makes it possible to further improve the signal-to-noise ratio in the capture variables.

The at least one interference analysis can be advantageously carried out between two and ten times, in particular four times. The signal-to-noise ratio is improved further with each pass of the at least one interference analysis. If the analysis is carried out four times, the signal-to-noise ratio is improved in particular by a factor of 2.

In a further advantageous configuration of the method, a plurality of different electromagnetic beams can be transmitted into the same scene of the monitoring region and respective capture variables can be determined,
at least one interference analysis can be respectively carried out for at least a portion of the plurality of capture variables determined in this manner and respective purged capture variables can be determined for at least a portion of the transmitted different electromagnetic beams,
and at least a portion of the plurality of purged capture variables determined in this manner can be combined to form at least one combination capture variable.

This makes it possible to further improve the signal-to-noise ratio in the capture variables.

In order to capture the same scene, the different electromagnetic beams can be transmitted within an accordingly small time window.

A plurality of different electromagnetic beams can be advantageously transmitted in succession into the same scene of the monitoring region. This makes it possible to avoid the transmitted electromagnetic beams from interfering with one another.

Four different electromagnetic beams can be advantageously transmitted into the same scene, respective capture variables can be determined and respective interference analyses can be carried out. This makes it possible to implement an accordingly small time window, and so changes in the captured scene are as small as possible.

The different electromagnetic beams may differ in terms of shape, wavelength, pulse duration, transmission duration, transmission power, coding or the like. The corresponding echo receive variables can be better distinguished from any interference variables by varying the transmitted electromagnetic beams. The interference variables can therefore be better identified and removed.

In a further advantageous configuration of the method, an artificial convolutional neural network can be used as at least one artificial neural network. An artificial convolutional neural network (CNN) is a machine learning concept inspired by biology with the aim of extracting features. Since noise has patterns, in particular interference patterns, which differ from patterns, in particular object patterns, of regular signals, in particular of echo beams, the capture variables captured can be accordingly reduced after recognizing the interference patterns. In this case, it is even possible to vary the electromagnetic beams which are transmitted into the monitoring region using the detection apparatus for scanning. In this way, the at least one interference analysis can be used to determine which electromagnetic beams stem from beams transmitted by the detection apparatus. Interfering noise can be identified from this knowledge and accordingly removed by calculation.

In a further advantageous configuration of the method,
during the at least one interference analysis, the at least one capture variable can be initially examined for known object patterns caused by electromagnetic echo beams reflected at known objects,
and, if at least one known object pattern is recognized, an echo capture variable corresponding to the at least one known object pattern can be removed from the at least one capture variable,
the at least one capture variable freed of the recognized at least one echo capture variable can then be examined for known interference patterns of interference variables using at least one artificial neural network and, if at least one known interference pattern is recognized, the original at least one capture variable, which can contain the at least one echo capture variable, can be purged of interference variables belonging to the at least one recognized interference pattern. This makes it possible to improve the signal-to-noise ratio even further.

As a result of the fact that the at least one capture variable is initially freed of echo capture variables with the aid of known object patterns, corresponding interference patterns can be identified in an even better manner. The freeing of the original capture variables from interference variables can therefore be improved.

To some extent, the object patterns caused by objects whose object pattern is already known can be initially removed from the at least one original capture variable. The capture variable freed of the object patterns can then be subjected to at least one further interference analysis, during which the interference variables with known interference patterns can be recognized. The recognized interference variables can then be removed from the at least one original capture variable, and so this purged capture variable ideally contains only echo variables of objects, provided that all interference variables have been identified.

In a further advantageous configuration of the method,
predefined interference patterns and/or possibly object patterns can be used for the at least one interference analysis
and/or
interference patterns and/or object patterns learned during operation of the detection apparatus can be used for the at least one interference analysis. In this manner, the method can more flexibly access a greater number of known interference patterns and/or known object patterns.

Predefined interference patterns and/or object patterns can be used in the at least one interference analysis. These patterns can be learned in advance, in particular under laboratory conditions, and can be stored in corresponding storage media, in particular storage media of the detection apparatus. In this manner, it is possible to more quickly access the corresponding interference patterns and/or object patterns when carrying out the method.

Alternatively or additionally, interference patterns and/or object patterns learned during operation can be used. This makes it possible to continuously increase the number of known interference patterns and/or object patterns. This also makes it possible to continuously improve the method.

In a further advantageous configuration of the method,
receive signals, in particular electrical receive signals, that are converted from electromagnetic beams using a receiving device of the detection apparatus can be used as capture variables,
and/or
object information relating to objects captured during measurements with the detection apparatus can be used as capture variables, wherein the object information is determined from receive signals, in particular electrical receive signals, which are converted from electromagnetic beams using a receiving device of the detection apparatus. In this manner, the at least one interference analysis can be carried out on a suitable processing level.

Receive signals can be advantageously used as capture variables. The interference analysis can therefore be carried out directly with the receive signals on a lower processing level. In this manner, interference variables can be removed very early.

Electrical receive signals, in particular electrical voltage variables or the like, can be advantageously used as capture variables. The electrical receive signals are produced during the conversion of the electromagnetic beams using means, in particular receiving devices, of the detection apparatus. Electrical receive signals can be processed using electrical means, in particular electrical evaluation devices or the like.

The receive signals can be echo receive signals which stem from echo beams, interference signals which stem from interference beams, or a superimposition of echo receive signals and interference signals.

Alternatively or additionally, object information can be used as capture variables. In this manner, the interference analysis can be carried out on a higher processing level. The validity of images with object information, in particular distance images, can thus be improved.

In a further advantageous configuration of the method, the method can be used to operate a detection apparatus in the form of a radar sensor that is used to transmit electromagnetic beams in the form of radar beams.

Radar sensors are very variable with respect to the transmitted radar beams. This also makes it possible to vary the capture variables in order to improve a distinction of object patterns and interference patterns. The same scene can therefore be scanned, in particular in succession, using different radar beams. The signal-to-noise ratio can therefore be improved overall in the purged capture variables.

At least one receiving device of the detection apparatus, in particular of the radar sensor, can be advantageously configured to receive electromagnetic beams, in particular radar beams, of the same type as the electromagnetic beams transmitted using the detection apparatus.

A wavelength range, in which the at least one receiving device can receive electromagnetic beams, can advantageously comprise the wavelength range, in which the electromagnetic beams, in particular radar beams, are emitted using the detection apparatus. This makes it possible to ensure that at least echoes of the transmitted electromagnetic beams, in particular the radar beams, can be received.

In a further advantageous configuration of the method, at least one purged capture variable, in particular possibly at least one purged combination capture variable, can be processed further, in particular can be subjected to image processing, and/or
at least one transmitting device and/or at least one receiving device of the detection apparatus can be adjusted on the basis of the at least one purged capture variable, in particular possibly the at least one purged combination capture variable.

At least one purged capture variable, in particular possibly at least one purged combination capture variable, can be advantageously processed further. This makes it possible to obtain further information relating to the monitoring region.

At least one item of object information, in particular at least one distance variable, at least one direction variable and/or at least one speed variable, can be advantageously determined from at least one purged capture variable, in particular possibly from at least one purged combination capture variable. This makes it possible to characterize the captured scenes more accurately.

At least one purged capture variable, in particular possibly at least one purged combination capture variable, can be advantageously subjected to image processing. This makes it possible to remove further interference effects.

Alternatively or additionally, at least one transmitting device and/or at least one receiving device of the detection apparatus can be adjusted on the basis of the at least one purged capture variable, in particular possibly the at least one purged combination capture variable. This makes it possible to adapt the performance of the detection apparatus to the prevailing situation.

Furthermore, the object is achieved, according to the invention, in the case of the detection apparatus by virtue of the fact that the detection apparatus has at least a portion of means for carrying out the method according to the invention.

According to the invention, the detection apparatus has at least one interference analysis means that can be used to carry out an interference analysis according to the invention.

The detection apparatus may advantageously have at least one artificial neural network, in particular an artificial convolutional neural network. Capture variables can be examined for known interference patterns of interference variables using the artificial neural network when carrying out interference analyses and, if known interference patterns are recognized, the capture variables can be purged of interference variables belonging to recognized interference patterns.

Interference patterns can be recognized even better using artificial convolutional neural networks.

In one advantageous embodiment, the detection apparatus may be a radar sensor. A monitoring region can be contactlessly monitored for objects using a radar sensor. Radar sensors can be variably adjusted based on the emitted radar beams. In particular, the shape, pulse duration, length and/or coding or the like of radar beams can thus be varied. A larger quantity of capture variables can be determined for the same captured scene in this manner using radar sensors by transmitting different radar beams into the same scene. The identification of interference patterns can thus be further improved.

The object is furthermore achieved, according to the invention, in the case of the driver assistance system by virtue of the fact that the driver assistance system has at least a portion of means for carrying out the method according to the invention.

According to the invention, the driver assistance system has at least one detection apparatus and at least a portion of means for carrying out the method according to the invention for operating the at least one detection apparatus.

A vehicle can be operated autonomously or semiautonomously using the driver assistance system.

At least one monitoring region in the environment of the vehicle and/or in the interior of the vehicle can be monitored for objects using a detection apparatus. Distance variables, direction variables and/or speed variables, which characterize distances, directions and/or speeds of captured objects, can be determined using the at least one detection apparatus. The information obtained using the at least one detection apparatus can be used with the driver assistance system for autonomously or semiautonomously operating the vehicle.

According to the invention, the driver assistance system has at least a portion of means for carrying out the method according to the invention. At least one detection apparatus of the driver assistance system may advantageously have at least a portion of means for carrying out the method according to the invention. If the at least one detection apparatus is part of the driver assistance system, the portion of the means of the at least one detection apparatus for carrying out the method according to the invention is therefore also part of the driver assistance system, that is to say also part of the means of the driver assistance system for carrying out the method according to the invention. This accordingly applies to the means of the vehicle having at least one driver assistance system and/or at least one detection apparatus.

The object is furthermore achieved, according to the invention, in the case of the vehicle by virtue of the fact that the vehicle has at least a portion of means for carrying out the method according to the invention.

The vehicle may advantageously have at least one driver assistance system, in particular at least one driver assistance system according to the invention. The vehicle can be operated autonomously or semiautonomously using the driver assistance system.

Alternatively or additionally, the vehicle may have at least one detection apparatus, in particular at least one detection apparatus according to the invention. At least one monitoring region in the environment of the vehicle and/or in the interior of the vehicle can be monitored for objects using a detection apparatus.

At least one detection apparatus, in particular at least one detection apparatus according to the invention, can be advantageously connected to or be part of a driver assistance system, in particular at least one driver assistance system according to the invention. In this manner, information obtained using the at least one detection apparatus can be used by the driver assistance system for autonomously or semiautonomously operating the vehicle.

Moreover, the features and advantages indicated in connection with the method according to the invention, the detection apparatus according to the invention, the driver assistance system according to the invention and the vehicle according to the invention and the respective advantageous configurations thereof apply in a mutually corresponding manner and vice versa. The individual features and advantages may of course be combined with one another, in which case further advantageous effects extending beyond the sum of the individual effects may result.

### BRIEF DESCRIPTION OF THE DRAWINGS

Further advantages, features and details of the invention will become apparent from the following description, in which exemplary embodiments of the invention are explained in more detail with reference to the drawing. A person skilled in the art will expediently also consider the features disclosed in combination in the drawing, the description and the claims individually and combine them to form further useful combinations. In the drawing, schematically,

FIG. 1 shows a front view of a vehicle with a driver assistance system having a radar sensor;

FIG. 2 shows a functional diagram of the driver assistance system with the radar sensor from FIG. 1;

FIG. 3 shows the temporal profile of an electrical raw receive signal determined from a radar echo signal and electromagnetic interference beams using a receiving device of the radar sensor from FIGS. 1 and 2, and the temporal profiles of the corresponding electrical echo receive signal and the electrical interference signals;

FIG. 4 shows the temporal profile of the raw receive signal from FIG. 3;

FIG. 5 shows the temporal profile of the echo receive signal from FIG. 3;

FIG. 6 shows a flowchart for a method for operating the radar sensor from FIGS. 1 and 2.

In the figures, identical components are provided with the same reference signs.

### EMBODIMENT(S) OF THE INVENTION

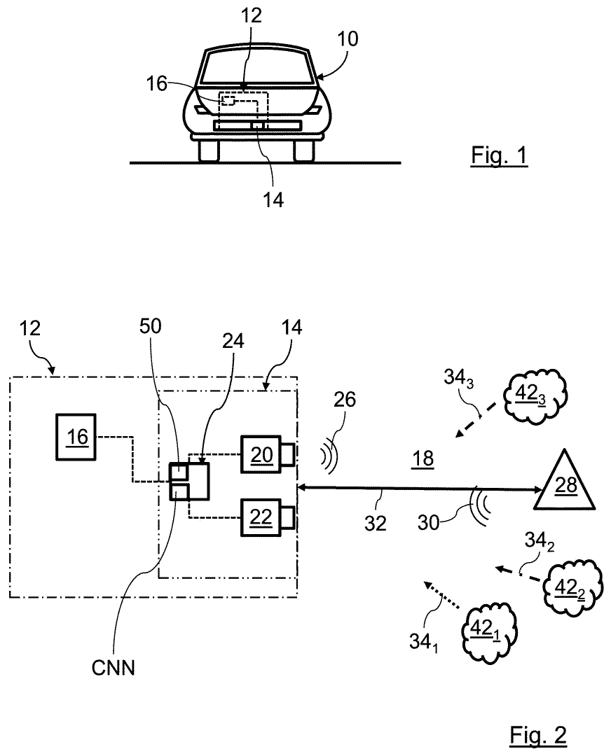

FIG. 1 shows the front view of a vehicle 10 in the form of an automobile. The vehicle 10 has a driver assistance system 12. The vehicle 10 may be operated autonomously or semiautonomously using the driver assistance system 12. FIG. 2 shows the driver assistance system 12 in a functional diagram.

The driver assistance system 12 comprises a detection apparatus in the form of a radar sensor 14. Furthermore, the driver assistance system 12 has a central processor unit 16. radar sensor 14 is arranged by way of example in the front fender of the vehicle 10 and is directed into a monitoring region 18 in the direction of travel in front of the vehicle 10. The radar sensor 14 can also be arranged at a different location on the vehicle 10, and oriented differently. The driver assistance system 12 may also have a plurality of radar sensors 14 which may be arranged at different locations on the vehicle 10 with different orientations. The driver assistance system 12 may additionally also have different detection apparatuses.

The invention is explained by way of example using the one radar sensor 14 illustrated in FIGS. 1 and 2. However, the invention can accordingly also be used for other radar sensors or other detection apparatuses that use electromagnetic beams to monitor a corresponding monitoring region.

The radar sensor 14 comprises a transmitting device 20 having for example a transmitting antenna Tx, a receiving device 22 having for example a receiving antenna Rx and a control and evaluation device 24, for example an electronic control and evaluation device.

The transmitting device 20 and the receiving device 22 are each functionally connected to the control and evaluation device 24. This makes it possible to exchange information between the transmitting device 20, the receiving device 22 and the control and evaluation device 24.

The control and evaluation device 24 is connected to the central processor unit 16 of the driver assistance system 12. This makes it possible to exchange information between the radar sensor 14, or the control and evaluation device 24, and the central processor unit 16.

The radar sensor 14 may also be equipped with a plurality of transmitting antennas Tx and a plurality of receiving antennas Rx. The radar sensor 14 may be in the form of a Multiple Input Multiple Output (MIMO) radar sensor.

The transmitting device 20 can be used, for example, to generate electrical scanning signals which can be transmitted, as electromagnetic scanning beams in the form of radar signals 26, into the monitoring region 18 using the transmitting antenna Tx. The radar signals 26 may be transmitted, for example, as radar pulses in the form of chirps. The transmitting device 20 can be used to vary the transmitted radar signals 26. For example, shapes, pulse durations, signal durations and/or codings or the like of the radar signals 26 can be varied.

The radar signals 26 can be reflected at objects 28 located in the monitoring region 18.

The radar sensor 14 can be used, for example, to capture stationary or moving objects 28, for example vehicles, persons, animals, plants, obstacles, uneven road surfaces, for example potholes or rocks, road boundaries, traffic signs, open spaces, for example parking spaces, precipitation or the like, and/or movements and/or gestures.

Radar signals 26 which are reflected at the objects 28 in the direction of the radar sensor 14 can be received as electromagnetic beams in the form of radar echo signals 30 using the receiving antenna Rx of the receiving device 22.

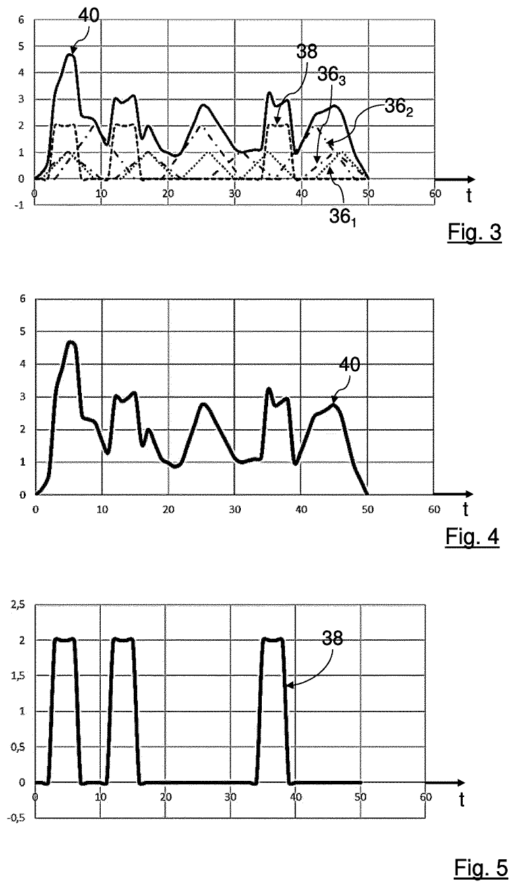

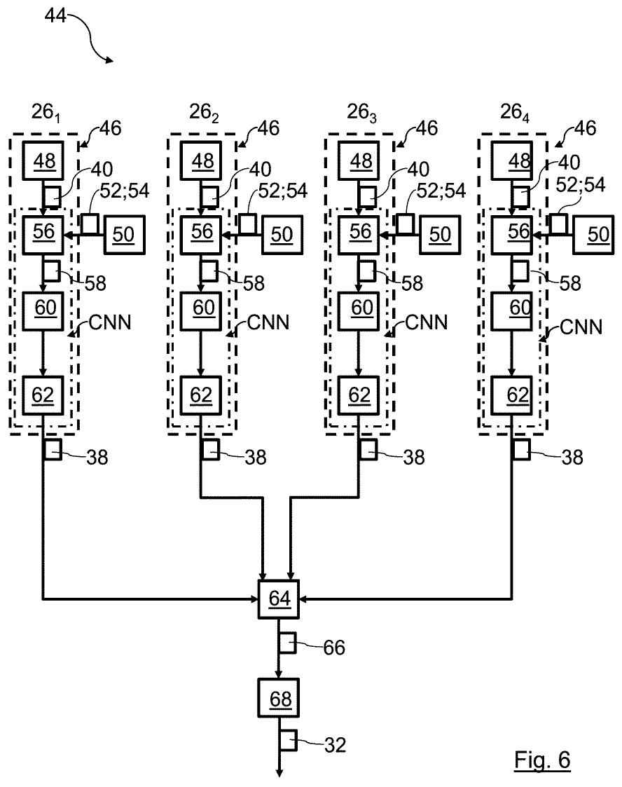

The received radar echo signals 30 can be converted into capture variables in the form of electrical echo receive signals 38 using the receiving device 22. FIGS. 3 and 5 illustrate the temporal profile of an exemplary electrical echo receive signal 38 which results from the radar echo signals 30 of an exemplary radar signal 26.

Depending on a propagation time of a transmitted radar signal 26 until the corresponding radar echo signal 30 is received, object information relating to the captured object 28 can be determined. For example, it is possible to determine distance variables 32, direction variables and speed variables which characterize distances, directions and speeds of captured objects 28 within a reference system, for example relative to the radar sensor 14. An indirect or direct propagation time method can be used. When using an MIMO radar sensor 14, distance variables 32 can be determined from phase differences between electrical scanning signals, which are used to generate the radar signals 26, and the electrical echo receive signals 38 of the captured radar echo signals 30.

The object information is determined in the control and evaluation device 24.

In addition to the radar echo signals 30, which come from captured objects 28, the receiving antennas Rx of the receiving device 22 are also used to receive electromagnetic interference beams 34 which come, for example, from external interference sources 42. The electromagnetic interference beams 34 are converted into electrical interference signals 36 using the receiving device 22.

The interference sources 42 may be, for example, other radar sensors which emit interference beams 34 in the form of radar beams. FIG. 2 shows, by way of example, three interference sources 42, the reference signs of which are provided with the indices 1, 2 and 3 for better distinction. The reference signs of the corresponding electrical interference signals 36, the temporal profiles of which are indicated in FIG. 3, are accordingly denoted using the indices 1, 2 and 3.

The electrical echo receive signals 38, which stem from echo signals 30, and the electrical interference signals 36 are superimposed to form a capture variable in the form of an electrical raw receive signal 40. FIGS. 3 and 4 show, by way of example, the temporal profile of the raw receive signal 40 for the scene shown in FIG. 2 with the three interference sources 42₁, 42₁ and 42₃.

The raw receive signal 40 is dependent on the type, the material, the shape and the spatial position, for example the position in a defined reference system, of the reflecting object 28. Furthermore, the raw receive signal 40 is dependent on the environmental conditions, for example prevailing precipitation or the like, external noise, the dynamics of the environment or of the captured object 28. In addition, the raw receive signal 40 is dependent on the radar signals 26 used.

For comparison, FIG. 3 shows the temporal profiles of the exemplary electrical raw receive signal 40, the corresponding echo receive signal 38 and the three electrical interference signals 36₁, 36₂ and 36₃.

The electrical interference signals 36₁, 36₂ and 36₃ stem from the three interference sources 42₁, 42₂ and 42₃ which each emit electromagnetic interference beams 34₁, 34₂ and 34₃.

FIG. 4 shows only the temporal profile of the raw receive signal 40 from FIG. 3. FIG. 5 shows the temporal profile of the electrical echo receive signal 38 from FIG. 3 after an interference handling process, in which the interference signals 36₁, 36₂ and 36₃ were removed according to a method explained in more detail further below.

The interference signals 36 impair the signal-to-noise ratio for the echo receive signals 38. The accuracy of the determined object information relating to objects 28 captured by the radar sensor 14 is therefore impaired.

In order to be able to determine the most accurate possible object information relating to objects 28, for example accurate distance variables 32, accurate direction variables and/or accurate speed variables for objects 28, it is necessary to improve the signal-to-noise ratio.

For this purpose, an interference handling process is carried out in a method 44 for operating the radar sensor 14. The method 44 is illustrated as a flowchart in FIG. 6.

During the interference handling process, interference analyses 46 are carried out with the aid of an artificial neural network. The neural network is implemented as a convolutional neural network CNN, for example.

Four interference analyses 46 are carried out, by way of example, in the method 44. More or fewer interference analyses 46 may also be carried out. The signal-to-noise ratio is improved with the number of interference analyses 46.

A radar signal 26 is transmitted for each of the interference analyses 46 and the corresponding echo signals 30 are captured and converted into raw receive signals 40. The four interference analyses 46 are carried out for the same scene in the monitoring region 18 at a short interval of time. A different variation of a radar signal 26 is used for each of the interference analyses 46, with the result that four different variations of radar signals 26 are used for the four interference analyses 46. For the sake of simple distinction, the reference signs of the four different variations of the radar signals 26 are provided with the indices 1, 2, 3 and 4 below.

For the sake of easier clarity, the four interference analyses 46 are indicated at the same level in the flowchart in FIG. 6. The interference analyses 46 and the corresponding radar measurements take place in temporal succession. The sequence and the principle of the four interference analyses 46 are identical. Therefore, the same reference signs are used in the illustrations. In a manner representative of all four interference analyses 46, the interference analysis 46 for the radar signal 26₁, on the left in FIG. 6, is explained in more detail below using the example of the scene shown in FIG. 2.

A radar measurement with the radar signal 26₁ is carried out in a measurement step 48. The corresponding echo signals 30 and the interference beams 34 from the interference sources 42 shown by way of example in FIG. 2 are received using the receiving antenna Rx of the receiving device 22 and are converted into an electrical raw receive signal 40. The temporal profile of the raw receive signal 40 is illustrated in FIGS. 3 and 4.

The raw receive signal 40 is transmitted to the neural network CNN.

In addition, known interference patterns 52 of known electrical interference signals, and known object patterns 54 of known objects 28 are transmitted from a pattern memory 50 to the neural network CNN. The pattern memory 50 is part of the control and evaluation device 24, for example.

An interference pattern 52 is characterized by the temporal profile of an electrical interference signal 36. The known interference patterns 52 may be patterns of interference signals 36 that usually occur when operating the vehicle 10. For example, the known interference signals 36 may stem from interference beams 34 transmitted by radar sensors of other vehicles.

An object pattern 54 is characterized by the temporal profile of an electrical echo receive signal 38. The known object patterns 54 may be, for example, patterns of echo receive signals 38 of objects 28 that usually occur during operation of the vehicle 10. Known objects 28 may be, for example, vehicles, persons, animals, plants, obstacles, uneven road surfaces, for example potholes or rocks, road boundaries, traffic signs, open spaces, for example parking spaces, or the like.

The known interference patterns 52 and the known object patterns 54 are determined, for example, in advance, for example at the end of a production line, by means of reference measurements using known interference sources 42 or known objects 28 and are stored in the pattern memory 50. The reference measurements may be carried out under laboratory conditions, for example. Alternatively or additionally, known interference patterns 52 and/or known object patterns 54 may also be recorded, for example “learned”, during normal operating situations of the vehicle 10.

In the described exemplary embodiment, it is assumed that corresponding known interference patterns 52 are stored in the pattern memory 50 for the interference signals 36 from the scene in FIG. 2. It is also assumed that corresponding known object patterns 54 are stored in the pattern memory 50 for the echo receive signals 38 of the object 28 shown there, for example a road sign.

The raw receive signal 40 is compared with the known object patterns 54 in the neural network in an object purging step 56. Pattern recognition methods, for example, can be carried out for this purpose. If a match to a known object pattern 54—the object pattern 54 of the road sign in the present case—is identified, the raw receive signal 40 is reduced by the identified echo receive signal 38 of the known object pattern 54, namely of the road sign, and is supplied as a reduced receive signal 58 to an interference analysis step 60.

In the interference analysis step 60, the reduced receive signal 58 is compared with the known interference patterns 52. Pattern recognition methods, for example, can be carried out for this purpose. If a match to known interference patterns 52 is recognized, the original raw receive signal 40 is reduced by the interference signals 36 of the corresponding known interference patterns 52 in a purging step 62. In the exemplary embodiment shown, the patterns of the interference signals 36, which are caused by the interference beams 34₁, 34₁ and 34₃ from the three interference sources 42₁, 42₁ and 42₃ shown in the scene in FIG. 2, match, for example, corresponding known interference patterns 52 stored in the pattern memory 50. The original raw receive signal 40 is therefore reduced by the interference signals 36₁, 36₁ and 36₃.

After removing the effect of the recognized interference signals 36₁, 36₁ and 36₃, only the echo receive signal 38 which has been purged of interference and stems from the reflecting object 28, namely the road sign, remains if all interference signals 36₁, 36₁ and 36₃ occurring during the measurement are identified using the known interference patterns 52.

The purged echo receive signals 38 determined in each of the four exemplary interference analyses 46 are combined to form a combination echo receive signal 66 in a superimposition step 64.

In an information determination step 68, the object information, for example the distance variables 32, the direction variables and/or speeds, for the captured object 28 is determined from the combination echo receive signal 66.

Optionally, the object information can be subjected to further processing, for example image processing.

The object information, for example the distance variables 32, is transmitted to the central processor unit 16 of the driver assistance system 12.

Optionally, settings of the transmitting device 20 and/or of the receiving device 22 can be adapted to the present scene on the basis of the combination echo receive signal 66.

Instead of being carried out on the basis of the raw receive signals 40 as capture variables, the interference analysis 46 may also be carried out on the basis of object information, for example distance variables 32, direction variables and/or speed variables, as capture variables. The object information is determined in this case in advance on the basis of the corresponding raw receive signals 40.

1. A method for operating a detection apparatus for a vehicle, the method comprising:
transmitting at least one electromagnetic beam into a monitoring region of the detection apparatus using the detection apparatus;
receiving at least one electromagnetic beam coming from the monitoring region using the detection apparatus and is converted into at least one capture variable that can be processed using at least one evaluation device;
carrying out at least one interference handling process on the basis of at least one capture variable using at least one artificial neural network;
carrying out at least one interference analysis during the at least one interference handling process:;
examining, in the at least one interference analysis, the at least one capture variable for known interference patterns of interference variables using at least one artificial neural network; and
purging, if at least one known interference pattern is recognized, the at least one capture variable of interference variables belonging to the at least one recognized interference pattern.

2. The method as claimed in claim 1, further comprising:
carrying out the at least one interference analysis repeatedly; and
combining the purged capture variables determined from the respective interference analyses to form at least one combination capture variable.

3. The method as claimed in claim 1, further comprising:
transmitting a plurality of different electromagnetic beams into the same scene of the monitoring region and respective capture variables are determined,
carrying out, respectively, at least one interference analysis for at least a portion of the plurality of capture variables determined in this manner;
determining respective purged capture variables for at least a portion of the transmitted different electromagnetic beams; and
combining at least a portion of the plurality of purged capture variables determined in this manner to form at least one combination capture variable.

4. The method as claimed in claim 1 wherein an artificial convolutional neural network is used as at least one artificial neural network.

5. The method as claimed in claim 1 further comprising:
examining, during the at least one interference analysis, the at least one capture variable for known object patterns caused by electromagnetic echo beams reflected at known objects;
removing, if at least one known object pattern is recognized, an echo capture variable corresponding to the at least one known object pattern from the at least one capture variable;
examining the at least one capture variable freed of the recognized at least one echo capture variable for known interference patterns of interference variables using at least one artificial neural network; and
purging, if at least one known interference pattern is recognized, the original at least one capture variable, which can contain the at least one echo capture variable, of interference variables belonging to the at least one recognized interference pattern.

6. The method as claimed in claim 1
wherein predefined interference patterns and/or possibly object patterns are used for the at least one interference analysis, and/or
wherein interference patterns and/or object patterns learned during operation of the detection apparatus are used for the at least one interference analysis.

7. The method as claimed in claim 1
wherein receive signals, that are converted from electromagnetic beams using a receiving device of the detection apparatus are used as capture variables, and/or
wherein object information relating to objects captured during measurements with the detection apparatus is used as capture variables,
wherein the object information is determined from receive signals which are converted from electromagnetic beams using a receiving device of the detection apparatus.

8. The method as claimed in claim 1 wherein the method is used to operate a detection apparatus in the form of a radar sensor that is used to transmit electromagnetic beams in the form of radar beams.

9. The method as claimed in claim 1
wherein at least one purged capture variable is processed further including image processing, and/or
wherein at least one transmitting device and/or at least one receiving device of the detection apparatus is/are adjusted on the basis of the at least one purged capture variable.

10. A detection apparatus for a vehicle, the detection apparatus comprises:
at least one transmitting device for transmitting electromagnetic beams into a monitoring region of the detection apparatus,
at least one means for receiving electromagnetic beams coming from the monitoring region and for determining capture variables from received electromagnetic beams
at least one means for carrying out interference handling processes on the basis of capture variables, wherein the at least one means has at least one artificial neural network,
wherein the detection apparatus has at least a portion of means for carrying out the method as claimed in claim 1

11. The detection apparatus as claimed in claim 10, wherein the detection apparatus (14) is a radar sensor.

12. A driver assistance system for a vehicle, having at least one detection apparatus, wherein the at least one detection apparatus comprises:
at least one transmitting device for transmitting electromagnetic beams into a monitoring region of the at least one detection apparatus,
at least one means for receiving electromagnetic beams coming from the monitoring region and for determining capture variables from the received electromagnetic beams,
at least one means for carrying out interference handling processes on the basis of capture variables, wherein the at least one means has at least one artificial neural network,
wherein the driver assistance system has at least a portion of means for carrying out the method as claimed in claim 1.

13. A vehicle having at least one detection apparatus, wherein the at least one detection apparatus comprises:
at least one transmitting device for transmitting electromagnetic beams into a monitoring region of the at least one detection apparatus,
at least one means for receiving electromagnetic beams coming from the monitoring region and for determining capture variables from the received electromagnetic beams,
at least one means for carrying out interference handling processes on the basis of capture variables, wherein the at least one means has at least one artificial neural network,
wherein the vehicle has at least a portion of means for carrying out the method as claimed in claim 1.
